(19) United States
(12) Patent Application Publication
(10) Pub. No.: US 2006/0180523 A1
(43) Pub. Date: Aug. 17, 2006

(54) Devices and systems for dimensionally separating particles from a mass of particles of various sizes and shapes

(76) Inventor: Desmond E. Smith, Snohomish, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/249,753

(22) Filed: Oct. 13, 2005

Related U.S. Application Data
(60) Provisional application No. 60/618,657, filed on Oct. 13, 2004.

(51) Int. Cl. B07B 13/05

(52) U.S. Cl. 209/667

(57) ABSTRACT

An agitation element adapted for use with other agitation elements on the rollers of a roller screen, having a substantially planar and triangular body with a central opening therethrough for mounting the agitation element onto the roller, the opening being adapted such that the body of the agitation element lies generally perpendicularly with respect to the axis of rotation of the roller when the agitation element is mounted on the roller for operation. Another agitation element has an edge defining a closed perimeter with substantially linear sides, each side being angled with respect to each adjacent side by less than ninety degrees. In particular embodiments, the angle can be as low as approximately sixty degrees. Still another agitation element incorporates a body having an edge defining a closed polygon with adjacent sides that intersect each other at a peak and wherein a maximum distance, measured from the geometric center of the polygon to at least one of the peaks is approximately 1.5-2.25 times greater than a minimum distance, measured from the geometric center of the polygon to the midpoint of one of the sides. In particular embodiments, the ratio can be 1.5-1.75, and in one particular embodiment, the ratio is approximately 1.6.

### BACKGROUND OF THE INVENTION

1. Field of the Invention

The present invention relates to devices and systems for separating and/or sorting materials, and, in particular, for separating wood strands and shavings from fines and superfines in a mass of wood particles.

2. Description of the Related Art

In the manufacture of OSB panels, it is often necessary or desirable to process a mass of wood particles to separate it into wood strands, chips, shavings and/or wafers, on one hand, and microstrands, fines and/or superfines, on the other. The former group can be used in the manufacture of OSB panels, while the latter can be used, and if necessary further separated, in the manufacture of paper, particle board or other products.

One difficulty in separating the particles results from the fact that the shavings and strands in the mass of particles often entrap the fines and microstrands, preventing the strands and microstrands from being removed using traditional separation means, such as vibrators and prior art roller beds.

In an attempt to solve this problem, the apparatus shown and described in U.S. patent application No. US 22004/0069693A1 to Paladin replaces the knurled protruberances on a prior art roller bed with square riddling elements to further agitate the mass as it travels across the roller bed.

Considerable experimentation has shown, however, that such a design may be insufficient, or at least less than optimal, in separating microstrands, fines and superfines from thick or densely packed masses of wood particles, or in other situations.

### BRIEF SUMMARY OF THE INVENTION

The present invention is directed toward devices and systems for use when separating particles from a mass of particles based on their size and/or shape. One embodiment of the invention is directed toward a particular agitation element adapted for use with other agitation elements on the rollers in a roller screen. This particular agitation element has a substantially planar and triangular body with a central opening therethrough. The opening is sized and shaped to conform to the outer surface of the roller, and is adapted such that the body of the agitation element lies generally perpendicularly with respect to the axis of rotation of the roller when the agitation element is mounted on the roller for operation. This element also incorporates a means for being rotationally fixing with respect to the roller such that the roller and the agitation element rotate as a unit about the axis of rotation during operation.

In another embodiment, the body of the agitation element has an edge defining a closed perimeter. The body has substantially linear sides extending about the perimeter, each side being angled with respect to each adjacent side by less than ninety degrees.

In still another embodiment, the body has an edge defining a closed polygon. Each side of the polygon intersects with each adjacent side at a peak. A maximum distance, measured from the geometric center of the polygon to at least one of the peaks is 1.5-2.25 times greater than a minimum distance, measured from the geometric center of the polygon to the midpoint of one of the sides. In particular embodiments, the ratio can be 1.5-1.75, and in one particular embodiment, the ratio is approximately 1.6.

The present invention is also directed toward rollers that incorporate shafts and agitation elements, such as those described above. The invention is further directed toward roller screens incorporating several such rollers in a bed, which are controlled to rotate simultaneously in the same direction to separate materials based on size and/or shape.

### BRIEF DESCRIPTION OF THE SEVERAL VIEWS OF THE DRAWING(S)

In order to assist understanding of the present invention, embodiments will now be described, purely by way of non-limiting example, with reference to the attached drawings, in which:

FIG. 1 is a plan view of a portion of a roller screen, according to an embodiment of the invention;

FIG. 2 is a side elevation view of a portion of the roller screen of FIG. 1;

FIG. 3 is an end elevation view of the portion of the roller screen of FIG. 1;

FIGS. 4-6 are side elevation views of a portion of a roller screen according to an embodiment of the present invention, schematically illustrating the agitation elements on three adjacent shafts in distinct angular orientation;

FIGS. 7-9 illustrate three possible embodiments of agitation elements according to the present invention;

FIG. 10 further illustrates the agitation element of FIG. 7; and

FIG. 11 is a side schematic of one possible embodiment of a roller screen according to the present invention, during use.

### DETAILED DESCRIPTION OF THE INVENTION

The present invention is directed toward devices and systems for separating and/or sorting particulate materials in a mass, based on the size of the particle. The following is a detailed description of a few illustrative embodiments. The drawings are provided to clarify the description, and may not be to scale.

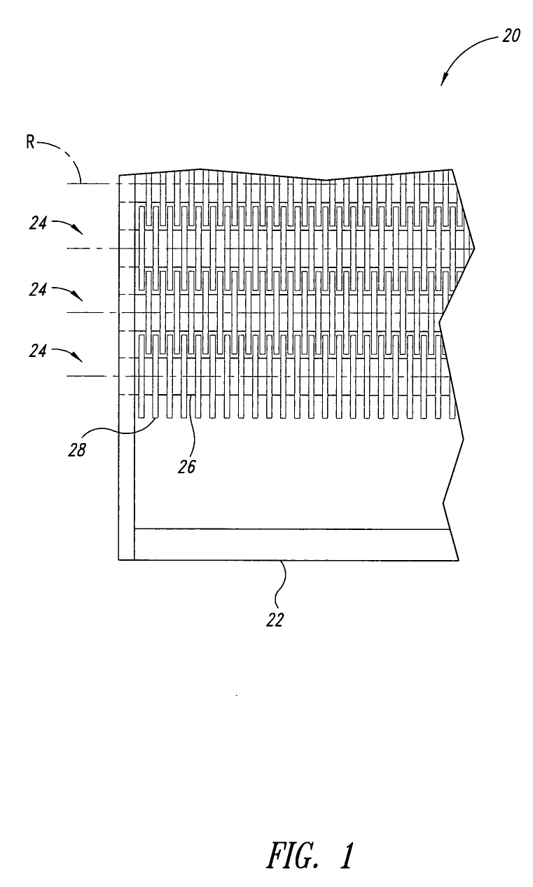

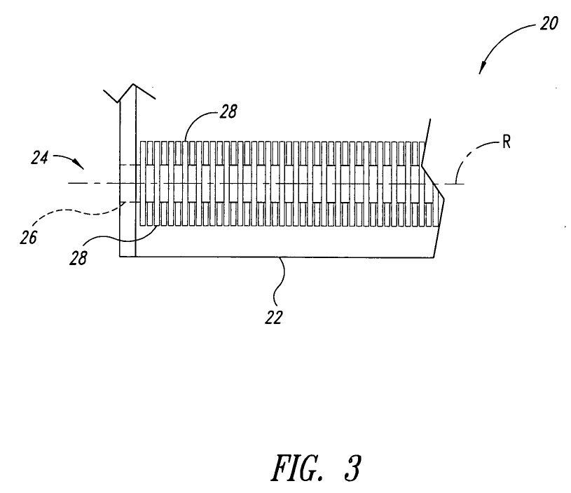

FIGS. 1-3 illustrate a roller screen 20, or roller bed, according to one possible embodiment of the present invention. The roller screen 20 generally incorporates a frame 22 and several rollers 24. The illustrated rollers 24 are parallel and spaced apart from each other along the length of the roller screen 20. The rollers 24 are rotatably mounted to the frame 22, and can be coupled to a chain, a motor, a belt and/or some other drive. Each of the rollers 24 rotates about an axis of rotation, “R.”

As best illustrated in FIG. 1, each roller 24 incorporates a shaft 26 and a number of agitation elements 28 projecting transversely outward from the shaft and spaced apart from each other along an operating portion of the length of the shaft. The illustrated agitation elements are flat and thin in the direction parallel to the shaft 26. Other than the end shafts, the agitation elements 28 are interleaved with the agitation elements on the two adjacent rollers 24. The end rollers 24, as a result of their relative positioning, have only one adjacent roller.

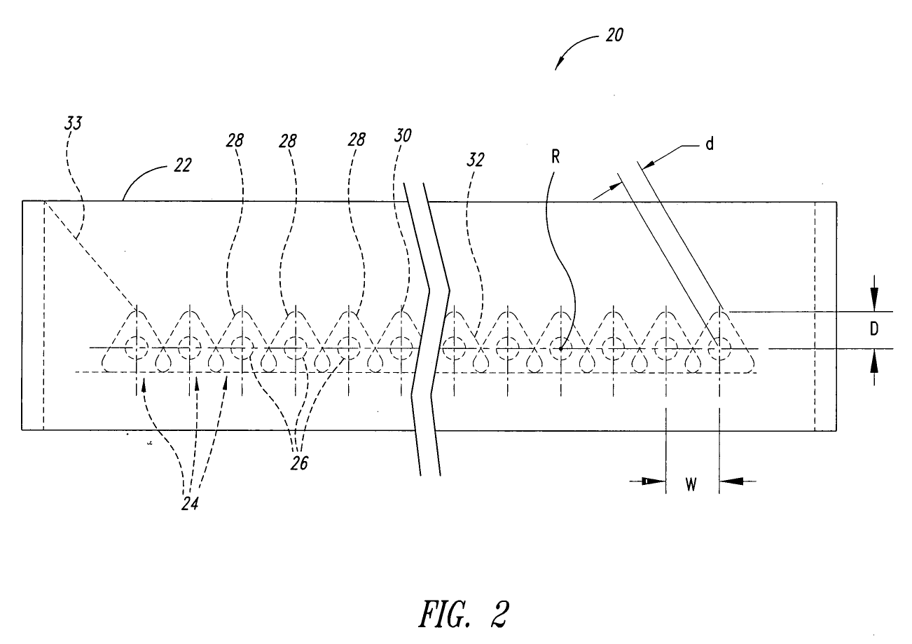

As best illustrated in FIG. 2, the agitation elements 28 in this particular embodiment are generally triangular in shape, having three peaks 30 and three sides 32. The illustrated agitation element 28 has a rounded corner at each of the peaks 30. At least one of the three peaks 30 of each triangular agitation member 28 projects a maximum distance “D” from the axis of rotation R. A minimum distance “d” is measured from the axis of rotation R to the midpoint of at least one of the sides 32. In the illustrated embodiment, the maximum distance D for all three peaks are equal and the minimum distance d for all three sides are equal.

The shafts 26 in this embodiment are spaced apart from each other by a constant distance “w”, which as discussed in more detail below, is slightly greater than the maximum distance D, allowing the rollers 24 to rotate without the agitation elements 28 impinging the adjacent shafts 26.

During operation, a mass of particles (e.g., strands, shavings, microstrands, fines and/or microfines) is introduced onto the roller screen 20 at a first end and the rollers 24 are rotated such that the tops of the agitation elements 28 rotate toward an opposing second end. A ramp 33 can be used to introduce the particles onto the roller screen 20 down stream of the first roller 24. The mass of particles moves from the first end of the roller screen 20 to the second end and, along the way, the smaller, undesirable particles in the mass that contact the roller screen 20 can fall through gaps in the roller screen, thereby being separated from the mass. In addition, each time a roller 24 rotates another 120 degrees under a portion of the mass of particles, that portion of the mass moves vertically up and down over a distance calculated by the difference between the widest portion of the agitation element 28 and the narrowest portion of the agitation element. This agitation can cause additional undesirable particles to be freed from the mass and screened by the system. Still further, some of the engagement elements 28 can penetrate into or through the mass and can cause some of the mass to tumble and/or break up, releasing even more undesirable particles from within the mass. Still further, the rollers 24 in the latter portion of the roller screen 20 can be configured to rotate faster—for example, by using additional gears—such that the mass of particles is pulled apart when some of it lays on the slower rollers and some of it comes into contact with the faster rollers. Each of these above actions facilitates the removal of smaller, undesirable particles from the mass.

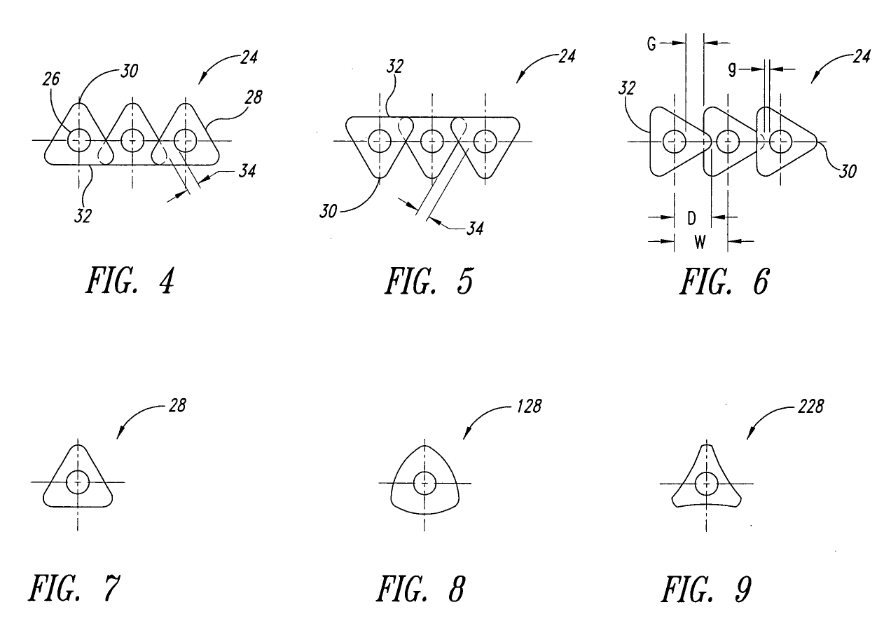

FIGS. 4-6 illustrate three adjacent rollers 24 rotating through three distinct orientations, respectively. In FIG. 4, the agitation elements 28 are aligned with each other with one of their peaks 30 projecting vertically upward and an opposing side 32 extending horizontally across the bottom; in FIG. 5, the agitation elements have been rotated clockwise 60 degrees with respect to FIG. 4, such that one of the sides extends horizontally across the top and a peak projects vertically downward; and in FIG. 6, the agitation elements have been rotated clockwise another 30 degrees with respect to FIG. 5 such that a peak is projecting horizontally to the right and an opposing side is extending vertically along the left edge.

As each roller 24 rotates, the distance the agitation element 28 projects toward one of the adjacent shafts 26 increases and decreases—one cycle every 120 degrees—from a minimum distance “d” to a maximum distance “D” then back to the minimum distance. As a result, a gap 34 between the terminal edge of the agitation element 28 and an outer surface of the adjacent shaft 26 decreases and increases, respectively, between a maximum gap “G” and a minimum gap “g” (see FIG. 6). As illustrated in FIGS. 4 and 5, the gap 34 is measured as the shortest distance between an agitation element 28 and the adjacent shaft 26, as that smallest dimension is the primary limiting factor in determining—at any given time—whether a particle moving across the top of the roller screen 20 will fall through the roller screen and be separated from the mass of particles. By adjusting the size of each agitation element 28 and/or the spacing W of the shafts, the maximum gap G and minimum gap g can be increased or decreased as desired.

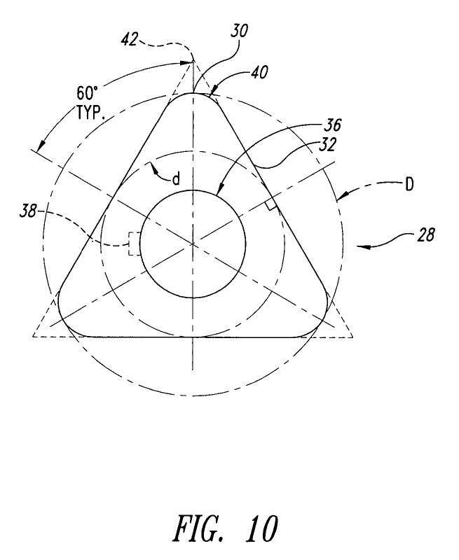

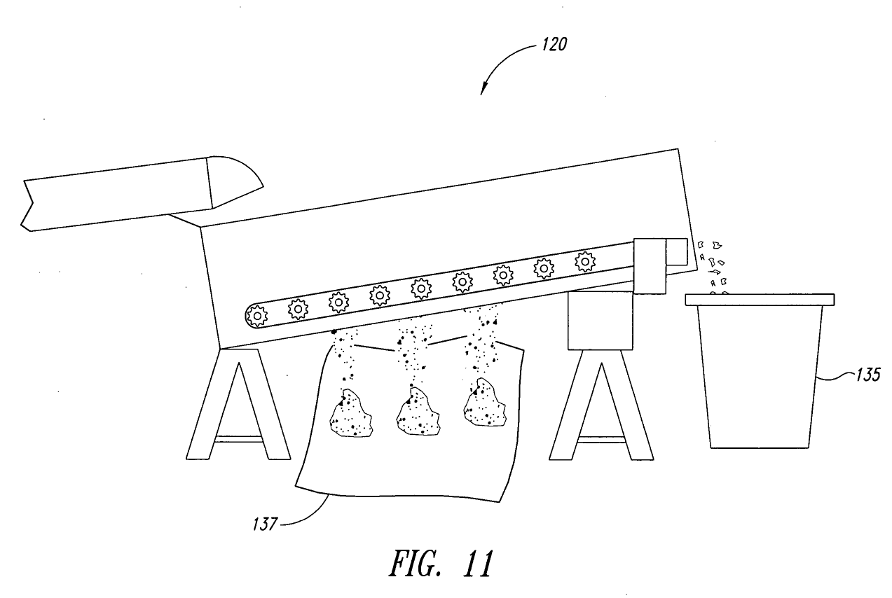

FIGS. 7 and 10 better illustrate the agitation element 28 of the above-discussed embodiment. The agitation element 28 has an opening 36 that complements a mounting surface on the shaft 26. The opening 36 can be manufactured with a keyway 38 or other equivalent feature for fixing the agitation element 28 to the shaft 26 so that the two rotate as a unit about the axis of rotation R. Alternatively, the agitation element 28 can be welded to the shaft 26 or can be formed integrally with the shaft, such as by molding, forging or other suitable means.

In the illustrated embodiment, the sides 32 of the engagement element 28 are all equidistant from the center of the opening 36 and, as a result, the minimum distance d is the same for all three. Similarly, all three peaks 30 are equidistant from the center of the opening and, as a result, the maximum distance D is the same for all three. In the illustrated embodiment, the peaks 30 have rounded ends 40; however, the agitation element 28 can be formed with angular ends 42. The rounded ends 40 can be adjusted to more closely approximate the angular ends 42, if desired.

For the embodiment illustrated in FIG. 10 with rounded ends 40, an “agitation ratio,” defined herein as the ratio of the maximum dimension D to the minimum dimension d (i.e., agitation ratio=“D/d”), is approximately 1.6. The applicant has conducted considerable experimentation and has determined that, for optimal performance, the agitation ratio should be in the broad range of 1.5 to 2.25. During operation, a system with an agitation ratio below 1.5 does not agitate the mass of particles sufficiently to remove all of the smaller, less desirable particles when the retained particles are desired for use in manufacturing OSB panels or similar products. A more preferred agitation ratio is from 1.5 to 1.8. Notably, for the device illustrated in FIG. 10 having angular ends 42, the agitation ratio is 2.0. The alternate agitation element 128 illustrated in FIG. 8 has an agitation ratio approaching 1.5, while the alternate agitation element 228 illustrated in FIG. 9 has an agitation ratio approaching 2.25. It is noted that FIGS. 7-9 may not be to scale.

The agitation ratio of the prior art, which is square in shape, is approximately 1.4 or, if the corners were rounded, even lower. Applicant has witnessed considerable, unforeseen benefit of using an agitation ratio of greater than 1.5.

FIG. 11 schematically illustrates one particular model of the system 120 during use. The system can be set up such that the first, or introductory, end of the system is lower than the second, or terminal, end of the system, to still further increase the effectiveness of the present system.

In one particular embodiment, the agitation elements can be densely interleaved with approximately ⅛″ or 3 mm between adjacent faces, and the ends of the agitation elements can, at their closest point, be approximately ½″ from the adjacent shaft 26. In such an embodiment, the larger particles progress along the top of the screen and are ejected at the end (and into the receptacle 135 of FIG. 11), while smaller particles pass through the screen (and onto the tarp 137 in FIG. 11). One of ordinary skill in the art, having reviewed this entire disclosure, will appreciate variations that can be made to these respective dimensions, and the affect such changes will have on the size of chip selected by the system.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An agitation element for use with a plurality of other agitation elements on a roller, which is used with a plurality of other rollers in a roller screen, each roller each having an axis of rotation and an outer surface, the agitation element comprising:
a body having a shape that is at least substantially planar and triangular and having an opening therethrough located centrally with respect to the triangle, the opening being sized and shaped to conform to the outer surface of the roller and being oriented in the agitation element such that the body of the agitation element lies generally perpendicularly with respect to the axis of rotation of the roller when the agitation element is mounted on the roller for operation; and
means for rotationally fixing the agitation element with respect to the roller such that the roller and the agitation element rotate as a unit about the axis of rotation during operation.

2. The agitation element of claim 1 wherein the body is in the shape of an equilateral triangle.

3. The agitation element of claim 1 wherein the body is in the shape of a triangle with rounded corners.

4. The agitation element of claim 1 wherein the body is entirely planar.

5. The agitation element of claim 1 wherein the opening in the body is sized and shaped to conform to the outer surface of the roller about its entire perimeter.

6. The agitation element of claim 1 wherein the opening in the body is circular and is sized to conform to the outer surface of the roller about its entire perimeter.

7. The agitation element of claim 1 wherein the opening is oriented perpendicularly with respect to the plane of the body.

8. The agitation element of claim 1 wherein the means for rotationally fixing the agitation element with respect to the roller comprises a keyway.

9. The agitation element of claim 1 wherein the means for rotationally fixing the agitation element with respect to the roller comprises a compression coupling.

10. The agitation element of claim 1 wherein the body comprises a polymer.

11. The agitation element of claim 1 wherein the body comprises nylon.

12. The agitation element of claim 1 wherein the body comprises metal.

13. A roller for use with a plurality of other rollers in a roller screen having a frame and a motor, the roller comprising:
a shaft having opposing end portions configured to be coupled to the frame for rotating therein about an axis of rotation during operation, at least one of the end portions being adapted to be operatively coupled to the motor; and
a plurality of agitation elements fixedly coupled with respect to the shaft to rotate as a unit therewith, the agitation elements being spaced apart from each other along a working portion of the shaft, the agitation elements being at least substantially planar and triangular in shape and being oriented generally perpendicularly with respect to the axis of rotation of the shaft.

14. The roller of claim 13 wherein the agitation elements are aligned with each other.

15. The roller of claim 13 wherein the agitation elements are removably coupled to the shaft.

16. The roller of claim 13 wherein the agitation elements are removably coupled to the shaft with a compression coupling.

17. The roller of claim 13 wherein the agitation element has a first keyway formed in an interior surface thereof and the shaft has a second keyway formed in an outer surface thereof, and wherein the agitation element is fixed with respect to the shaft by a locking key positioned between the first and second keyways.

18. The roller of claim 13 wherein at least one of the end portions of the shaft has a bearing mounted thereon for rotational engagement with the frame.

19. The roller of claim 13 wherein at least one of the end portions of the shaft has a sprocket mounted thereon for engagement with a chain coupled to the motor.

20. A roller screen, comprising:
a frame;
a motor coupled to the frame; and
a plurality of rollers, each roller having a shaft that is rotatably coupled to the frame to rotate about an axis of rotation during operation, at least one end of each of the shafts being operatively coupled to the motor to controllably rotate in unison with the other rollers, each roller also having a plurality of agitation elements fixedly coupled with respect to the shaft to rotate as a unit therewith, the agitation elements being spaced apart from each other along a working portion of the shaft, the agitation elements being at least substantially planar and triangular in shape and being oriented generally perpendicularly with respect to the axis of rotation of the shaft.

21. The roller screen of claim 20 wherein each of the shafts has a sprocket at one end thereof, and further comprising a chain coupling the motor to each of the rollers.

22. An agitation element for use with a plurality of other agitation elements on a roller, which is used with a plurality of other rollers in a roller screen, each roller each having an axis of rotation and an outer surface, the agitation element comprising:
a substantially flat body having opposing surfaces and an edge defining a closed perimeter about each of the opposing surfaces, the body having a central opening extending therethrough from one of the surfaces to the opposing surface, the opening being sized and shaped to conform to the outer surface of the roller and being oriented in the agitation element such that the body of the agitation element lies generally perpendicularly with respect to the axis of rotation of the roller when the agitation element is mounted on the roller for operation, the body having a plurality of sides extending about the perimeter, each side being at least substantially linear and being angled with respect to each adjacent side by less than ninety degrees; and
means for rotationally fixing the agitation element with respect to the roller such that the roller and the agitation element rotate as a unit about the axis of rotation during operation.

23. The agitation element of claim 22 wherein each side is angled with respect to each adjacent side by substantially less than ninety degrees.

24. The agitation element of claim 22 wherein each side is angled with respect to each adjacent side by approximately sixty degrees.

25. A roller for use with a plurality of other rollers in a roller screen having a frame and a motor, the roller comprising:
a shaft having opposing end portions configured to be coupled to the frame for rotating therein about an axis of rotation during operation, at least one of the end portions being adapted to be operatively coupled to the motor; and
a plurality of agitation elements fixedly coupled with respect to the shaft to rotate as a unit therewith, the agitation elements being spaced apart from each other along a working portion of the shaft, the agitation elements being at least substantially planar and oriented generally perpendicularly with respect to the axis of rotation of the shaft, each agitation element having a plurality of sides extending about its perimeter, each side being at least substantially linear and being angled with respect to each adjacent side on that agitation element by less than ninety degrees.

26. The roller of claim 25 wherein each side is angled with respect to each adjacent side by substantially less than ninety degrees.

27. The roller of claim 25 wherein each side is angled with respect to each adjacent side by approximately sixty degrees.

28. A roller screen, comprising:
a frame;
a motor coupled to the frame; and
a plurality of rollers, each roller having a shaft that is rotatably coupled to the frame to rotate about an axis of rotation during operation, at least one end of each of the shafts being operatively coupled to the motor to controllably rotate in unison with the other rollers, each roller also having a plurality of agitation elements fixedly coupled with respect to the shaft to rotate as a unit therewith, the agitation elements being spaced apart from each other along a working portion of the shaft, the agitation elements being at least substantially planar and being oriented generally perpendicularly with respect to the axis of rotation of the shaft, each agitation element having a plurality of sides extending about its perimeter, each side being at least substantially linear and being angled with respect to each adjacent side on that agitation element by less than ninety degrees.

29. The roller screen of claim 28 wherein each side is angled with respect to each adjacent side by substantially less than ninety degrees.

30. The roller screen of claim 28 wherein each side is angled with respect to each adjacent side by approximately sixty degrees.

31. An agitation element for use with a plurality of other agitation elements on a roller, which is used with a plurality of other rollers in a roller screen, each roller each having an axis of rotation and an outer surface, the agitation element comprising:
a substantially flat body having opposing surfaces and an edge defining a closed polygon about each of the opposing surfaces, the body having an opening extending through the geometric center of the polygon, the opening being sized and shaped to conform to the outer surface of the roller and being oriented in the agitation element such that the body of the agitation element lies generally perpendicularly with respect to the axis of rotation of the roller when the agitation element is mounted on the roller for operation, the perimeter of the body comprising a plurality of sides intersecting to form the polygon, each side having a linear portion with a midpoint, and each side intersecting with each adjacent side at a peak, a maximum distance measured from the geometric center to at least one peak being at least approximately 1.5 times greater than a minimum distance measured from the geometric center to at least one midpoint; and
means for rotationally fixing the agitation element with respect to the roller such that the roller and the agitation element rotate as a unit about the axis of rotation during operation.

32. The agitation element of claim 31 wherein the ratio of the maximum distance to the minimum distance is in a range from about 1.5 to 2.25.

33. The agitation element of claim 31 wherein the ratio of the maximum distance to the minimum distance is substantially greater than 1.5.

34. The agitation element of claim 31 wherein the ratio of the maximum distance to the minimum distance is in a range from about 1.6 to 1.9.

35. The agitation element of claim 31 wherein the ratio of the maximum distance to the minimum distance is approximately 1.6.

36. The agitation element of claim 31 wherein the polygon has rounded corners.

37. A roller for use with a plurality of other rollers in a roller screen having a frame and a motor, the roller comprising:
a shaft having opposing end portions configured to be coupled to the frame for rotating therein about an axis of rotation during operation, at least one of the end portions being adapted to be operatively coupled to the motor; and
a plurality of agitation elements fixedly coupled with respect to the shaft to rotate as a unit therewith, the agitation elements being spaced apart from each other along a working portion of the shaft, the agitation elements being at least substantially planar and oriented generally perpendicularly with respect to the axis of rotation of the shaft, a perimeter of the body comprising a plurality of sides intersecting to form a closed polygon, each side having a linear portion with a midpoint, and each side intersecting with each adjacent side at a peak, a maximum distance measured from the geometric center to at least one peak being at least approximately 1.5 times greater than a minimum distance measured from the geometric center to at least one midpoint.

38. The roller of claim 37 wherein the ratio of the maximum distance to the minimum distance is in a range from about 1.5 to 2.25.

39. The roller of claim 37 wherein the ratio of the maximum distance to the minimum distance is substantially greater than 1.5.

40. The roller of claim 37 wherein the ratio of the maximum distance to the minimum distance is in a range from about 1.6 to 1.9.

41. The roller of claim 37 wherein the ratio of the maximum distance to the minimum distance is approximately 1.6.

42. The roller of claim 37 wherein the ratio of the maximum distance to the minimum distance is approximately 2.

43. A roller screen, comprising:
a frame;
a motor coupled to the frame; and
a plurality of rollers, each roller having a shaft that is rotatably coupled to the frame to rotate about an axis of rotation during operation, at least one end of each of the shafts being operatively coupled to the motor to controllably rotate in unison with the other rollers, each roller also having a plurality of agitation elements fixedly coupled with respect to the shaft to rotate as a unit therewith, the agitation elements being spaced apart from each other along a working portion of the shaft, the agitation elements being at least substantially planar and being oriented generally perpendicularly with respect to the axis of rotation of the shaft, each agitation element having a plurality of sides extending about its perimeter to form a closed polygon, each side having a linear portion with a midpoint, and each side intersecting with each adjacent side at a peak, a maximum distance measured from the geometric center to at least one peak being at least approximately 1.5 times greater than a minimum distance measured from the geometric center to at least one midpoint.

44. The roller screen of claim 43 wherein the ratio of the maximum distance to the minimum distance is in a range from about 1.5 to 2.25.

45. The roller screen of claim 43 wherein the ratio of the maximum distance to the minimum distance is substantially greater than 1.5.

46. The roller screen of claim 43 wherein the ratio of the maximum distance to the minimum distance is in a range from about 1.6 to 1.9.

47. The roller screen of claim 43 wherein the ratio of the maximum distance to the minimum distance is approximately 1.6.

48. The roller screen of claim 43 wherein the ratio of the maximum distance to the minimum distance is approximately 2.
